(19) United States
(12) Patent Application Publication
(10) Pub. No.: US 2025/0142391 A1
(43) Pub. Date: May 1, 2025

(54) RELAY DEVICE AND COMMUNICATION SYSTEM

(71) Applicant: NAGANO KEIKI CO., LTD., Tokyo (JP)

(72) Inventors: Takayuki Mizukoshi, Tokyo (JP); Hideki Muramatsu, Tokyo (JP); Masaki Yanagisawa, Tokyo (JP); Munenori Tsuchiya, Tokyo (JP)

(21) Appl. No.: 18/926,439

(22) Filed: Oct. 25, 2024

(30) Foreign Application Priority Data
Oct. 30, 2023 (JP) 2023-185330

(51) Int. Cl. H04W 24/10; H04W 88/04

(52) U.S. Cl. CPC H04W 24/10; H04W 88/04

(57) ABSTRACT

A relay device includes: a first communication section for establishing wireless communication according to a predetermined wireless communication standard between an external measurement device for transmitting measurement data and an external setting device for transmitting communication setting data relating to communication conditions; a second communication section for transmitting the measurement data received from the external measurement device to a data management unit according to another wireless communication standard different from the predetermined wireless communication standard for the first communication section; a storage for storing the measurement data and the communication setting data; and a communication controller for controlling the wireless communication by the first communication section and the second communication section based on the communication setting data stored in the storage.

### CROSS REFERENCE TO RELATED APPLICATIONS

The entire disclosure of Japanese Patent Application No. 2023-185330 filed Oct. 30, 2023 is expressly incorporated by reference herein.

### TECHNICAL FIELD

The present invention relates to a relay device and a communication system.

### BACKGROUND ART

An equipment monitoring controller configured to connect an equipment instrument and a client PC for monitoring the equipment instrument via the Internet has been typically known (see, for instance, Literature 1: JP 5027445 B2).

The equipment monitoring controller disclosed in Literature 1 includes a plurality of communication ports for being connected to the equipment instrument, and an identification-information assigning unit for assigning identification information to data received through each of the plurality of communication ports.

The equipment monitoring controller thus achieves the connection with a plurality of equipment instruments without changing a processor.

Meanwhile, it is requested for a relay device as disclosed in Literature 1 to set communication conditions (e.g., communication frequency of data) using a device such as a smartphone.

However, since the controller as disclosed in Literature 1 is not designed to be connectable to a device (e.g. a smartphone) for transmitting communication setting data, the communication conditions cannot be set by an external device.

### SUMMARY OF THE INVENTION

An object of the invention is to provide a relay device and a communication system capable of setting communication conditions using an external device.

A relay device according to an aspect of the invention includes: a first communication section configured to establish wireless communication with one or more external measurement devices and an external setting device according to a predetermined wireless communication standard, the one or more external measurement devices being configured to transmit measurement data, the external setting device being configured to transmit communication setting data relating to communication conditions; a second communication section configured to transmit the measurement data received from the one or more external measurement devices to an external device according to another wireless communication standard different from the predetermined wireless communication standard for the first communication section; a storage configured to store the measurement data and the communication setting data; and a communication controller configured to control the wireless communication by the first communication section and the second communication section based on the communication setting data stored in the storage.

According to the above aspect of the invention, the first communication section, which is configured to establish the wireless communication with the external setting device for transmitting the communication setting data relating to the communication conditions, is provided, where the communication controller is configured to control the wireless communication by the first communication section and the second communication section based on the communication setting data received by the first communication section. Accordingly, the communication conditions such as communication frequency of the data can be set using the external setting device (e.g. a smartphone). Further, the relay device, which is connected via the wireless communication with the one or more external measurement devices, the external setting device, and the external device in the above aspect of the invention, is not necessary to be connected with them by wire. Accordingly, the wiring work can be omitted.

In the relay device according to the above aspect of the invention, it is preferable that the relay device further includes: an operation section configured to receive an operation by a worker; and a mode switching section configured to switch a mode of the relay device between a first mode and a second mode in accordance with the operation made on the operation section, in the first mode the wireless communication being established between the one or more external measurement devices and the first communication section, in the second mode the wireless communication being established between the external setting device and the first communication section.

According to the above arrangement, the mode switching section for switching the mode between the first mode and the second mode in accordance with the operation made on the operation section is provided, so that the first mode and the second mode can be set at a timing desired by a worker.

It is preferable that the relay device according to the above aspect of the invention further includes a mode display configured to display the mode set by the mode switching section.

The mode display for displaying the operation mode in the above arrangement allows a worker to easily check a currently set operation mode.

In the relay device according to the above aspect of the invention, it is preferable that the mode display includes a plurality of display lamps.

According to the above arrangement, the mode display, which includes the plurality of display lamps, can be simplified in structure as compared with the case where the operation mode is displayed, for instance, on a liquid crystal screen or the like. The power consumption for the mode display can thus be reduced.

In the relay device according to the above aspect of the invention, it is preferable that a plurality of the external measurement devices are provided, and the communication controller is configured to sequentially establish the wireless communication between each of the plurality of external measurement devices and the first communication section based on the communication setting data stored in the storage.

The above arrangement, where the communication controller sequentially establish the wireless communication between each of the plurality of external measurement devices and the first communication section, allows the measurement data of the plurality of external measurement devices to be received using the single relay device. The number of the relay device can thus be reduced.

In the relay device according to the above aspect of the invention, it is preferable that the communication controller is configured to activate the first communication section and the second communication section at a predetermined time based on the communication setting data stored in the storage to establish the wireless communication between the one or more external measurement devices and the first communication section and between the external device and the second communication section.

According to the above arrangement, the measurement data can be transmitted from the external measurement device to the external device at a predetermined time.

In the relay device according to the above aspect of the invention, it is preferable that the communication controller is configured to activate the first communication section and the second communication section in accordance with the operation made on the operation section to establish the wireless communication between the one or more external measurement devices and the first communication section and between the external device and the second communication section.

According to the above arrangement, the wireless communication is established between the one or more external measurement devices and the first communication section and between the external device and the second communication section in accordance with the operation made on the operation section. Accordingly, the measurement data can be transmitted from the one or more external measurement devices to the external device at a timing desired by a worker.

A communication system according to another aspect of the invention includes the above relay device, the one or more external measurement devices, and the external device.

According to the other aspect of the invention, the same advantage(s) as described above can be achieved.

### BRIEF DESCRIPTION OF DRAWINGS

FIG. 1 schematically illustrates an arrangement of a communication system according to an exemplary embodiment of the invention.

FIG. 2 is a front elevational view schematically illustrating a relay device according to the exemplary embodiment.

FIG. 3 is an enlarged front elevational view illustrating a relevant part of the relay device according to the exemplary embodiment.

FIG. 4 is a block diagram schematically illustrating an overall arrangement of the relay device according to the exemplary embodiment.

FIG. 5 is a view illustrating a process for setting an operation mode of the relay device according to the exemplary embodiment.

FIG. 6 is a view illustrating a process for setting another operation mode of the relay device according to the exemplary embodiment.

FIG. 7 is a view illustrating a process for setting still another operation mode of the relay device according to the exemplary embodiment.

### DETAILED DESCRIPTION

### Exemplary Embodiment

An exemplary embodiment of the invention will be described below with reference to the attached drawings.

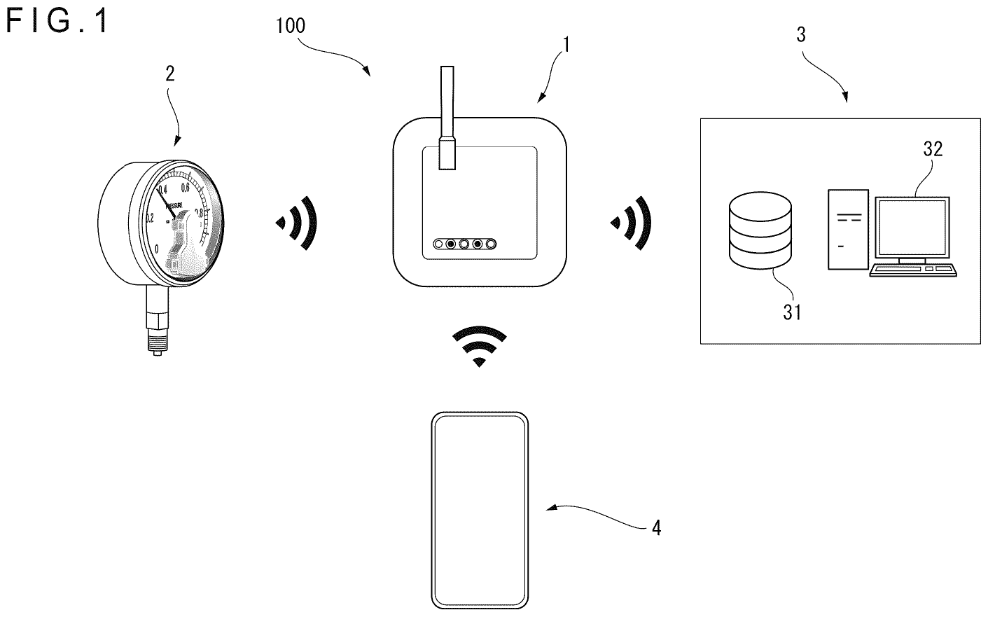

FIG. 1 schematically illustrates an arrangement of a communication system 100 according to the exemplary embodiment. The communication system 100 of the exemplary embodiment is configured to communicate measurement data measured by an external measurement device 2.

As illustrated in FIG. 1, the communication system 100 includes a relay device 1, the external measurement device 2, a data management unit 3, and an external setting device 4.

### Relay Device 1

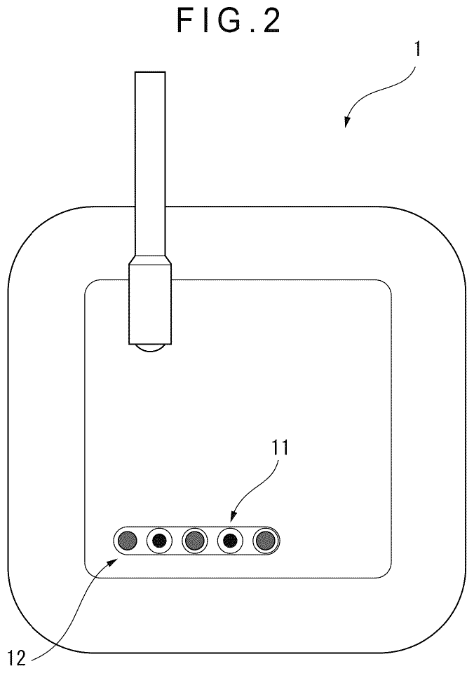

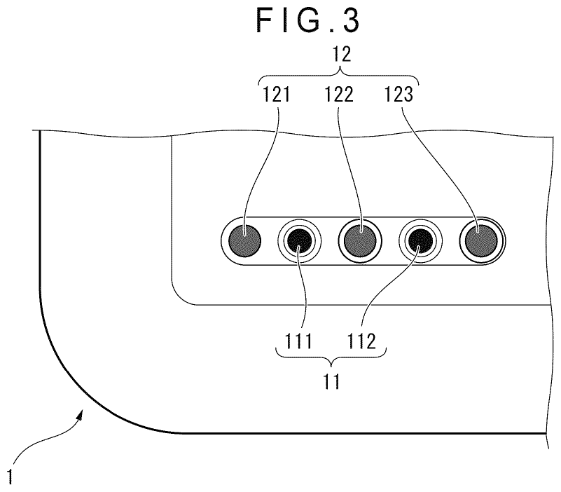

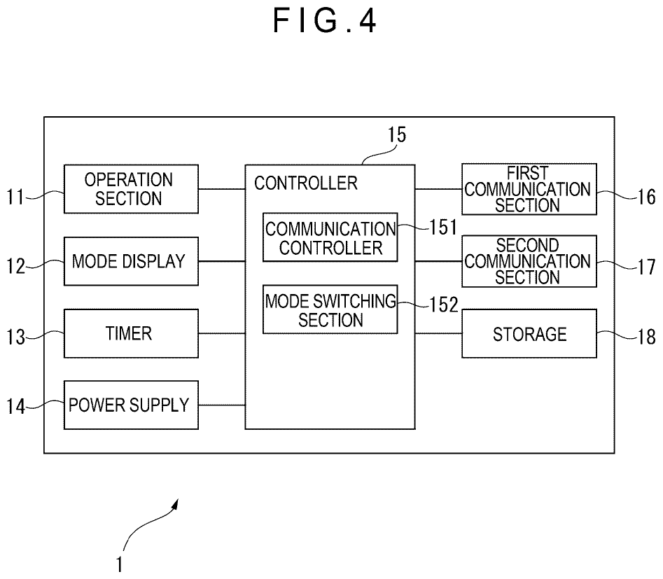

FIG. 2 is a front elevational view schematically illustrating the relay device 1. FIG. 3 is an enlarged front elevational view illustrating a relevant part of the relay device 1. FIG. 4 is a block diagram schematically illustrating an overall arrangement of the relay device 1. It should be noted that the relay device 1 of the exemplary embodiment is configured as a so-called base station capable of wireless communication with the external measurement device 2. In addition, the relay device 1 is capable of communication with the data management unit 3 through a network, which is, for instance, the Internet and/or Low Power Wide Area-network (LPWA). Furthermore, the relay device 1 is capable of wireless communication with the external setting device 4.

As illustrated in FIGS. 2 to 4, the relay device 1 includes an operation section 11, a mode display 12, a timer 13, a power supply 14, a controller 15, a first communication section 16, a second communication section 17, and a storage 18.

### Operation Section 11

The operation section 11 is used to operate the relay device 1. Specifically, the operation section 11 is used as an input section for switching on/off a power source, changing set values, and the like. In the exemplary embodiment, the operation section 11 includes a first operation button 111 and a second operation button 112. Details of the operation using the operation section 11 will be described later.

### Mode Display 12

The mode display 12 is configured as a display section for displaying an operation mode set on the relay device 1. In the exemplary embodiment, the mode display 12 includes a first mode display lamp 121, a second mode display lamp 122, and a third mode display lamp 123 that are each in a form of an LED display lamp. In other words, the mode display 12 of the exemplary embodiment includes a plurality of display lamps.

The mode display 12 for displaying the operation mode in the exemplary embodiment thus allows a worker to easily check the currently set operation mode. In addition, the mode display 12, which includes the plurality of display lamps, can be simplified in structure as compared with the case where the operation mode is displayed, for instance, on a liquid crystal screen or the like. The power consumption for the mode display 12 can thus be reduced.

### Timer 13

The timer 13 is capable of outputting an activation signal P to the controller 15 at a predetermined time based on communication setting data stored in the storage 18. In the exemplary embodiment, the timer 13 is capable of, for instance, switching the activation signal P from Low to High every hour on the hour.

The electric power from the power supply 14 is independently supplied to the timer 13. In other words, the electric power from the power supply 14 is supplied to the timer 13 even when the controller 15 is suspended.

### Power Supply 14

The power supply 14 is capable of supplying the electric power to the timer 13, the controller 15, and the like. The power supply 14 in the exemplary embodiment is in a form of a battery (e.g., a primary battery, or a secondary battery).

It should be noted that the power supply 14 is not necessarily configured as described above but may be configured, for instance, to be capable of supplying an external electric power.

### Controller 15

The controller 15 is provided by a central processing unit (CPU) and the like, and is configured to perform processing using the CPU running a program stored in the storage 18.

In the exemplary embodiment, the controller 15 includes a communication controller 151 and a mode switching section 152.

The communication controller 151 is configured to control wireless communication by the first communication section 16 and the second communication section 17 in accordance with the communication setting data stored in the storage 18 and an operation made on the operation section 11. More specifically, the communication controller 151 is configured to control the electric power supply from the power supply 14 to the first communication section 16 and the second communication section 17 to activate or deactivate the first communication section 16 and the second communication section 17.

It should be noted that how the first communication section 16 and the second communication section 17 are controlled by the communication controller 151 will be detailed later.

The mode switching section 152 is configured to switch the operation mode of the relay device 1 in accordance with the operation made on the operation section 11. Specifically, the mode switching section 152 is capable of switching operation modes of the relay device 1 among: a first mode in which the wireless communication is established between the relay device 1 and the external measurement device 2 and between the relay device 1 and the data management unit 3; a second mode in which the wireless communication is established between the external setting device 4 and the relay device 1; a third mode in which the wireless communication is established between the data management unit 3 and the relay device 1; and a fourth mode in which the power consumption of the relay device 1 is set low.

Details of each of the operation modes will be described later.

### First Communication Section 16

The first communication section 16 is configured to establish the wireless communication with the external measurement device 2 and the external setting device 4. In the exemplary embodiment, the first communication section 16 is configured to establish the wireless communication with the external measurement device 2 and the external setting device 4 via Bluetooth (registered trademark).

The wireless communication established between the first communication section 16 and the external measurement device 2 and between the first communication section 16 and the external setting device 4 will be detailed later.

### Second Communication Section 17

The second communication section 17 is configured to transmit the measurement data received from the external measurement device 2 to the data management unit 3 using a wireless communication standard different from that for the first communication section 16. In the exemplary embodiment, the second communication section 17 is configured to transmit the measurement data to the data management unit 3 through LPWA.

The storage 18 is provided by, for instance, Random Access Memory (RAM) and/or a non-volatile memory such as SD card, and is configured to store the measurement data received from the external measurement device 2 and the communication setting data received from the external setting device 4.

### External Measurement Device 2

Referring back to FIG. 1, the external measurement device 2 is capable of measuring physical quantities and transmitting the measured measurement data to the relay device 1. In the exemplary embodiment, the external measurement device 2 is provided in a form of a pressure gauge, and is configured to measure the pressure of a measurement target part. The external measurement device 2 is also configured to transmit the measured pressure data to the first communication section 16 of the relay device 1 via Bluetooth.

It should be noted that the external measurement device 2 is not necessary configured as described above but may be configured to, for instance, measure a flow rate of a fluid flowing in a pipe and transmit a flow-rate data. In other words, the external measurement device 2 may be configured in any manner as long as the external measurement device 2 is capable of transmitting measurement data of physical quantities.

### Data Management Unit 3

The data management unit 3 is a unit for storing the measurement data, as data, transmitted via the relay device 1 and for monitoring the data. It should be noted that the data management unit 3 is an example of the external device of the invention.

In the exemplary embodiment, the data management unit 3 includes a server device 31 and a client device 32.

The server device 31 is provided with a so-called server and is configured to store the measurement data. The client device 32 includes a so-called personal computer, and is configured to output and display the measurement data stored in the server device 31.

### External Setting Device 4

The external setting device 4 is in a form of a smartphone, a tablet terminal, and/or the like, and is configured to transmit the communication setting data relating to communication conditions to the relay device 1. In the exemplary embodiment, the external setting device 4 is configured to transmit the communication setting data including, for instance, identification information of the external measurement device 2 that is in wireless communication with the relay device 1, communication interval between the relay device 1 and the external measurement device 2, and a timing for the timer 13 to output the activation signal P.

### Process for Setting Operation Mode

Next, the process for setting the operation mode of the relay device 1 will be described below.

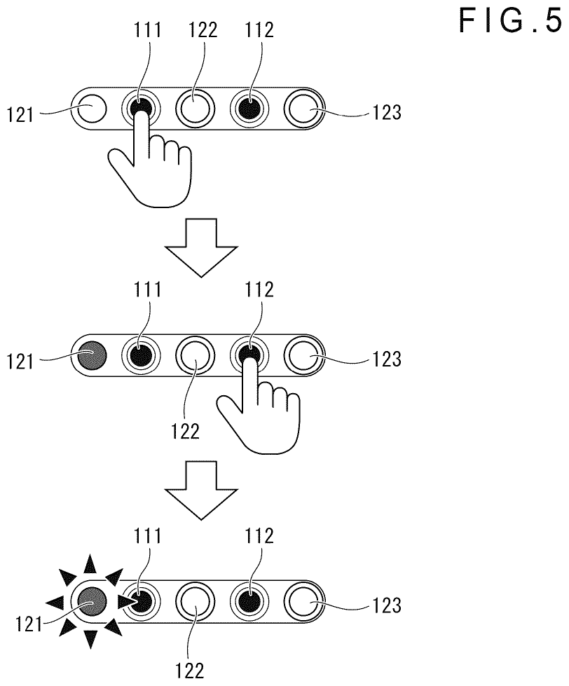

FIGS. 5 to 7 are each a view illustrating the process for setting the operation mode of the relay device 1.

Initially, in the fourth mode illustrated in FIG. 5 where the power consumption of the relay device 1 is set low, the first mode display lamp 121, the second mode display lamp 122, and the third mode display lamp 123 are put off. It should be noted that, while the relay device 1 is set in the fourth mode, the electric power is not supplied to the controller 15, the first communication section 16, and the second communication section 17 in order to reduce the power consumption.

When the first operation button 111 is long-pressed in this state, the first mode display lamp 121 lights up. The electric power also starts being supplied from the power supply 14 to the controller 15 by long-pressing the first operation button 111. When the second operation button 112 is subsequently long-pressed, the first mode display lamp 121 blinks, where the first mode is set by the mode switching section 152. It should be noted that the long-press in the exemplary embodiment refers to a state where the first operation button 111 or the second operation button 112 is pressed for two or more seconds.

When the first mode is set, the communication controller 151 starts supplying the electric power from the power supply 14 to the first communication section 16 and the second communication section 17 based on the activation signal P outputted at a predetermined time from the timer 13. The communication controller 151 then establishes the wireless communication between the first communication section 16 and the external measurement device 2 based on the communication setting data stored in the storage 18, and receives the pressure data as the measurement data from the external measurement device 2 to store the pressure data in the storage 18.

The communication controller 151 further establishes the wireless communication between the second communication section 17 and the data management unit 3 to transmit the pressure data stored in the storage 18 to the data management unit 3. When the pressure data is completely transmitted to the data management unit 3, the communication controller 151 stops supplying the electric power from the power supply 14 to the first communication section 16 and the second communication section 17.

As described above, when the relay device 1 of the exemplary embodiment is set at the first mode, the relay device 1 activates the controller 15, the first communication section 16, and the second communication section 17 per every predetermined time to receive the pressure data from the external measurement device 2 and transmit the pressure data to the data management unit 3. Accordingly, the measurement data can be transmitted from the external measurement device 2 to the data management unit 3 at a predetermined time.

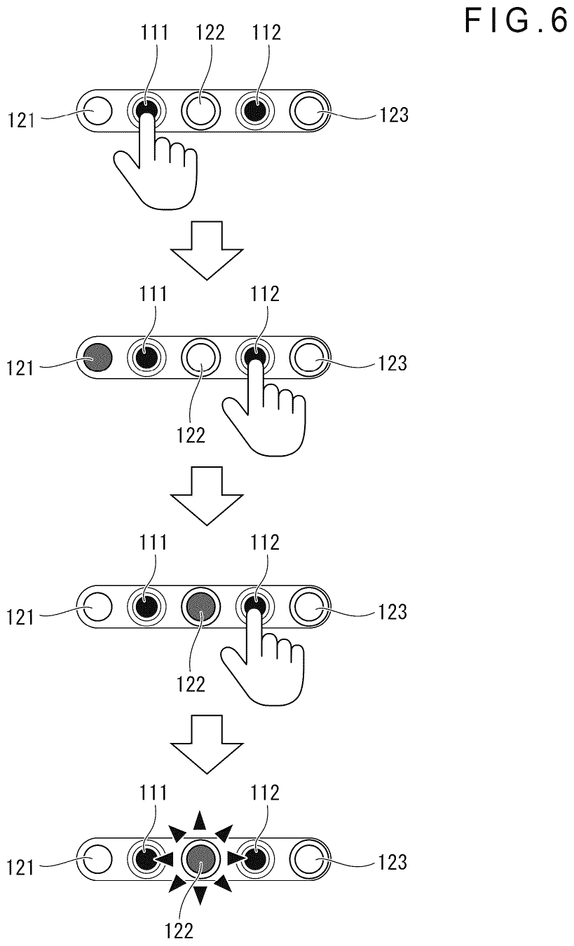

Next, when the first operation button 111 is long-pressed in the fourth mode as illustrated in FIG. 6, the first mode display lamp 121 lights up as described above and the electric power starts being supplied from the power supply 14 to the controller 15. When the second operation button 112 is short-pressed in this state, the second mode display lamp 122 lights up. When the second operation button 112 is long-pressed in this state, the second mode display lamp 122 blinks, where the second mode is set by the mode switching section 152. It should be noted that the short-press in the exemplary embodiment refers to a state where the first operation button 111 or the second operation button 112 is pressed for less than two seconds.

When the second mode is set, the communication controller 151 starts supplying the electric power from the power supply 14 to the first communication section 16. Then, the communication controller 151 establishes the wireless communication between the first communication section 16 and the external setting device 4, and receives the communication setting data relating to the communication conditions from the external setting device 4 to store the communication setting data in the storage 18.

As described above, the first communication section 16, which is configured to establish the wireless communication with the external setting device 4 for transmitting the communication setting data relating to the communication conditions, is provided in the exemplary embodiment, where the communication controller 151 is configured to control the wireless communication by the first communication section 16 and the second communication section 17 based on the communication setting data received by the first communication section 16. Accordingly, the communication conditions such as communication frequency of the data can be set using the external setting device 4 (e.g. a smartphone). Further, the relay device 1, which is connected via the wireless communication with the external measurement device 2, the data management unit 3, and the external setting device 4 in the exemplary embodiment, is not necessary to be connected with them by wire. Accordingly, the wiring work can be omitted.

Further, the mode switching section 152 for switching the operation mode between the first mode and the second mode in accordance with the operation made on the operation section 11 is provided in the exemplary embodiment, so that the first mode and the second mode can be set at a timing desired by a worker.

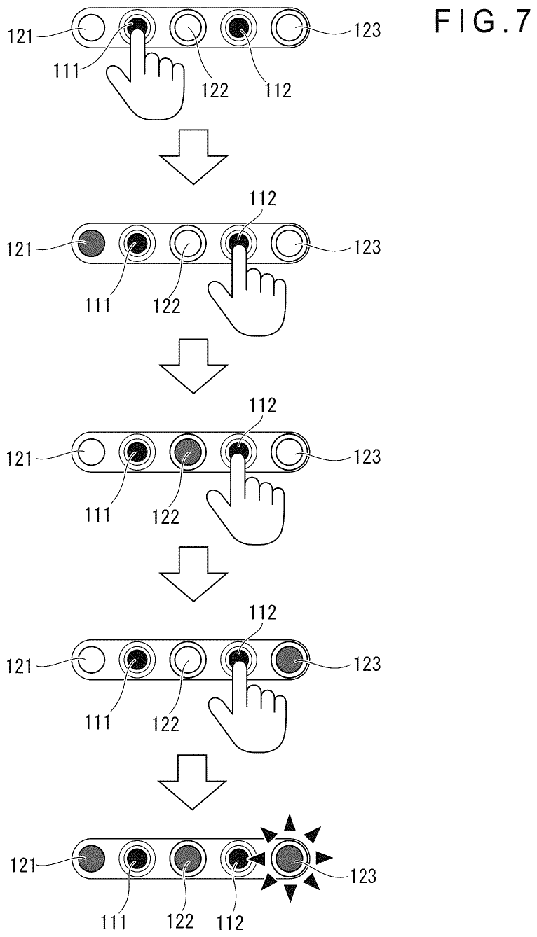

Next, when the first operation button 111 is long-pressed in the fourth mode as illustrated in FIG. 7, the first mode display lamp 121 lights up as described above and the electric power supply is started from the power supply 14 to the controller 15. When the second operation button 112 is short-pressed in this state, the second mode display lamp 122 lights up. Further, when the second operation button 112 is short-pressed, the third mode display lamp 123 lights up. When the second operation button 112 is long-pressed in this state, the third mode display lamp 123 blinks, where the third mode is set by the mode switching section 152.

When the third mode is set, the communication controller 151 starts supplying the electric power from the power supply 14 to the first communication section 16. Then, the communication controller 151 establishes the wireless communication between the first communication section 16 and the external measurement device 2, and receives the pressure data as the measurement data from the external measurement device 2 to store the pressure data as the measurement data in the storage 18.

Subsequently, the communication controller 151 starts supplying the electric power from the power supply 14 to the second communication section 17. The communication controller 151 then establishes the wireless communication between the second communication section 17 and the data management unit 3 to transmit the pressure data as the measurement data and the communication setting data stored in the storage 18 to the data management unit 3.

As described above, in the exemplary embodiment, the wireless communication is established between the external measurement device 2 and the first communication section 16 and between the data management unit 3 and the second communication section 17 in accordance with the operation made on the operation section 11. Accordingly, the measurement data and the communication setting data can be transmitted to the data management unit 3 at a timing desired by a worker.

### Effect of the Exemplary Embodiment

The following advantages can be achieved by the above-described exemplary embodiment.

(1) The first communication section 16, which is configured to establish the wireless communication with the external setting device 4 for transmitting the communication setting data relating to the communication conditions, is provided in the exemplary embodiment, where the communication controller 151 is configured to control the wireless communication by the first communication section 16 and the second communication section 17 based on the communication setting data received by the first communication section 16. Accordingly, the communication conditions such as the communication frequency of the data can be set using the external setting device 4 (e.g. a smartphone). Further, the relay device 1, which is connected via the wireless communication with the external measurement device 2, the data management unit 3, and the external setting device 4 in the exemplary embodiment, is not necessary to be connected with them by wire. Accordingly, the wiring work can be omitted.
(2) In the exemplary embodiment, the mode switching section 152 for switching the operation mode between the first mode, the second mode, the third mode, and the fourth mode in accordance with the operation made on the operation section 11 is provided, so that the operation mode can be set at a timing desired by a worker.
(3) The mode display 12 for displaying the operation mode in the exemplary embodiment allows a worker to easily check the currently set operation mode.

### Effect of Claim 4

(4) The mode display 12, which includes the plurality of display lamps in the exemplary embodiment, can be simplified in structure as compared with the case where the operation mode is displayed, for instance, on a liquid crystal screen or the like. The power consumption for the mode display 12 can thus be reduced.
(5) In the exemplary embodiment, the measurement data can be transmitted from the external measurement device 2 to the data management unit 3 at a predetermined time. The pressure data, as the measurement data, can be transmitted from the external measurement device 2 to the data management unit 3 at a predetermined time.

### Effect of Claim 7

(6) In the exemplary embodiment, the wireless communication is established between the external measurement device 2 and the first communication section 16 and between the data management unit 3 and the second communication section 17 in accordance with the operation made on the operation section 11. Accordingly, the pressure data, as the measurement data, can be transmitted from the external measurement device 2 to the data management unit 3 at a timing desired by a worker.

### Modifications

It should be noted that the invention is not limited to the above-described embodiment but includes modifications, improvements, and the like as long as an object of the invention can be achieved.

The relay device 1 is configured to establish the wireless communication with a single external measurement device 2 in the above exemplary embodiment. However, the relay device 1 is not necessarily configured as described above. For instance, the relay device may be configured to establish the wireless communication with a plurality of external measurement devices.

In this case, the communication controller may be configured to sequentially establish the wireless communication between each of the plurality of external measurement devices and the first communication section based on the communication setting data stored in the storage. The above arrangement, where the communication controller sequentially establishes the wireless communication between each of the plurality of external measurement devices and the first communication section, allows the measurement data of the plurality of external measurement devices to be received by the single relay device. The number of the relay device can thus be reduced.

The first communication section 16 is configured to establish the wireless communication with the external measurement device 2 and the external setting device 4 via Bluetooth in the above exemplary embodiment. However, the first communication section 16 is not necessarily configured as in the exemplary embodiment. For instance, the first communication section may be configured to establish the wireless communication with the external measurement device and the external setting device through wireless LAN (e.g. Wi-Fi).

The second communication section 17 is configured to transmit the measurement data to the data management unit 3 via LPWA in the above exemplary embodiment. However, the second communication section 17 is not necessarily configured as in the exemplary embodiment. For instance, the second communication section may be configured to transmit the measurement data to the data management unit through communication line such as the Internet. Alternatively or additionally, the second communication section may be configured to receive the data (e.g. the communication setting data) from the data management unit.

The first communication section 16 is configured to receive the communication setting data from the external setting device 4 via the wireless communication in the above exemplary embodiment. However, the first communication section 16 is not necessarily configured as in the exemplary embodiment. For instance, the first communication section may be configured to wirelessly transmit the measurement data and the currently set operation mode to the external setting device.

The mode display 12 includes the plurality of display lamps in the above exemplary embodiment. However, the mode display 12 is not necessarily configured as in the exemplary embodiment. For instance, the mode display may include a liquid crystal screen. In other words, the mode display may be configured in any manner as long as the mode display is capable of displaying the currently set operation mode.

What is claimed is:

1. A relay device comprising:
a first communication section configured to establish wireless communication with one or more external measurement devices and an external setting device according to a predetermined wireless communication standard, the one or more external measurement devices being configured to transmit measurement data, the external setting device being configured to transmit communication setting data relating to communication conditions;
a second communication section configured to transmit the measurement data received from the one or more external measurement devices to an external device according to another wireless communication standard different from the predetermined wireless communication standard for the first communication section;
a storage configured to store the measurement data and the communication setting data; and
a communication controller configured to control the wireless communication by the first communication section and the second communication section based on the communication setting data stored in the storage.

2. The relay device according to claim 1, further comprising:
an operation section configured to receive an operation by a worker; and
a mode switching section configured to switch a mode of the relay device between a first mode and a second mode in accordance with the operation made on the operation section, in the first mode the wireless communication being established between the one or more external measurement devices and the first communication section, in the second mode the wireless communication being established between the external setting device and the first communication section.

3. The relay device according to claim 2, further comprising:
a mode display configured to display the mode set by the mode switching section.

4. The relay device according to claim 3, wherein the mode display includes a plurality of display lamps.

5. The relay device according to claim 1, wherein
a plurality of the external measurement devices are provided, and
the communication controller is configured to sequentially establish the wireless communication between each of the plurality of external measurement devices and the first communication section based on the communication setting data stored in the storage.

6. The relay device according to claim 1, wherein
the communication controller is configured to activate the first communication section and the second communication section at a predetermined time based on the communication setting data stored in the storage to establish the wireless communication between the one or more external measurement devices and the first communication section and between the external device and the second communication section.

7. The relay device according to claim 2, wherein
the communication controller is configured to activate the first communication section and the second communication section in accordance with the operation made on the operation section to establish the wireless communication between the one or more external measurement devices and the first communication section and between the external device and the second communication section.

8. A communication system comprising:
the relay device according to claim 1;
the one or more external measurement devices; and
the external device.
